(19) United States
(12) Patent Application Publication
(10) Pub. No.: US 2024/0207127 A1
(43) Pub. Date: Jun. 27, 2024

(54) MASSAGE DEVICE

(71) Applicant: Precision Tool Technologies, Inc., Brainerd, MN (US)

(72) Inventors: James Gregory Goerges, Brainerd, MN (US); Robert Lee, Brainerd, MN (US)

(21) Appl. No.: 18/395,421

(22) Filed: Dec. 22, 2023

Related U.S. Application Data
(63) Continuation-in-part of application No. 29/870,397, filed on Jan. 25, 2023.
Application No. 29/870,397 is a continuation-in-part of application No. 29/843,961, filed on Jun. 24, 2022, now Pat. No. D026239.
(63) Continuation-in-part of application No. 29/870,398, filed on Jan. 25, 2023.
Application No. 29/870,398 is a continuation-in-part of application No. 29/843,960, filed on Jun. 24, 2022, now Pat. No. D025386.
(60) Provisional application No. 63/476,970, filed on Dec. 23, 2022.

(51) Int. Cl. A61H 7/00

(52) U.S. Cl. CPC A61H 7/003; A61H 2201/1253; A61H 2201/164; A61H 2201/1692; A61H 2205/12

(57) ABSTRACT

A massage device includes first and second end portions and an intermediate portion. The first end portion includes a first plurality of massage textures and a first plurality of lower surface elevations with a first end portion first width at the first textures greater than a first end portion second width at the first lower elevations. The second end portion includes a second plurality of massage textures and a second plurality of lower surface elevations with a second end portion first width at the second textures greater than a second end portion second width at the second lower elevations. The intermediate portion includes a third plurality of massage textures and a third plurality of lower surface elevations with an intermediate portion first width at the third textures greater than an intermediate portion second width at the third lower elevations.

### RELATED APPLICATIONS

This application claims priority to U.S. Provisional Patent Application No. 63/476,970, filed Dec. 23, 2022, which is incorporated herein by reference in its entirety. This application is a continuation-in-part of U.S. Design Patent Application No. 29/870,397, filed Jan. 25, 2023, which is a continuation of U.S. Design Patent Application No. 29/843,961, filed Jun. 24, 2022, and which are both incorporated by reference in their entirety. This application is a continuation-in-part of U.S. Design Patent Application No. 29/870,398, filed Jan. 25, 2023, which is a continuation of U.S. Design Patent Application No. 29/843,960, filed Jun. 24, 2022, and which are both incorporated by reference in their entirety.

### TECHNICAL FIELD

This disclosure generally relates to massage devices and massage methods. For example, embodiments disclosed herein can relate to massage devices and massage methods applied to tissue of the foot.

### BACKGROUND

Tissue inflammation and agitation in the foot can result from any of a variety of causes, including causes as simple as excess pressure applied to the foot, and, in some cases, without a discrete, discernible cause. One example condition of tissue inflammation in the foot is referred to as plantar fasciitis, which is inflammation of a band of tissue that connects the foot's heel bone to the foot's toes. Tissue inflammation in the foot, including plantar fasciitis, can be painful. Current therapeutic techniques used to attempt to treat include physical therapy, shoe inserts, steroid injections, and/or surgery.

### SUMMARY

As noted, current therapeutic techniques for tissue inflammation in the foot, such as plantar fasciitis, can include physical therapy, shoe inserts, steroid injections, and/or surgery. However, these current therapeutic techniques can be inefficient. For example, current therapeutic techniques, such as physical therapy, shoe inserts, steroid injections, and/or surgery can be expensive and/or require prolonged treatment timelines. Yet, while these current therapeutic techniques, such as physical therapy, shoe inserts, steroid injections, and/or surgery can at times be effective in remediating tissue inflammation in the foot, the tissue inflammation oftentimes returns, in many cases shortly after conclusion of the therapy, necessitating another round of therapy. As such, the cost associated with these current therapeutic techniques can become substantial over the course of what is oftentimes a significant number of rounds of therapy.

In general, various embodiments relating to massage devices as well as massage methods are disclosed herein. In particular, embodiments are disclosed herein in the context of massage devices and massage methods adapted to provide a therapeutic effect at tissue (e.g., soft tissue) of the foot. Such massage device and massage method embodiments disclosed herein can be effective in helping to treat and reduce inflammation at tissue of the foot yet, at the same time, provide a repeatable therapeutic function that can be utilized over a significant number of therapy rounds. Accordingly, massage device and massage method embodiments disclosed herein can provide a useful combination of efficacy in treating tissue inflammation at the foot while leveraging cost-efficiencies associated with repeated use of a single massage device as needed over a number of rounds of treatment (e.g., each morning when a user wakes up). Moreover, it may be the case that routine use of the massage device and/or massage method embodiments disclosed herein can help to prevent future instances of clinically significant foot inflammation.

For instance, a massage device embodiment can include a first end portion having a first end portion first width, a second end portion having a second end portion second width, and an intermediate portion, between the first end portion and the second end portion, having an intermediate portion first width, with the intermediate portion first width being greater than each of the first end portion first width and the second end portion first width. And, each of the first end portion, the second end portion, and the intermediate portion can include a plurality of massage textures that extend out from the respective portion and a plurality of lower surface elevations adjacent the plurality of massage textures. Such a configuration can provide a relatively protruded portion—the intermediate portion—between more relatively set back portions—the first end portion and the second end portion—such that a user can move his or her foot, or other body part, from a relatively set back portion—one of the first or second end portion—over a relatively protruded portion—the intermediate portion—and then over a relatively set back portion—the other of the first or second end portion all the while contacting the foot, or other body part, at the various the massage texture (e.g., and the various lower surface elevations) at each of the relatively set back and protruded portions. Moreover, this configuration can further include massage textures that extend out from the body of the massage device and lower surface elevations adjacent such extended massage textures such that a portion of a foot, when in contact with the massage device, can have a first foot portion in contact with one or more of the massage textures, while another, second foot portion that is adjacent the first foot portion can extend at least partially in between such massage textures and toward the lower surface elevations such that this second foot portion is at a lower elevation (e.g., closer to the central longitudinal axis) than the first foot portion that is contact with the one or more massage textures. It is believed that such a configuration of a massage device (e.g., the noted contouring and/or the extended massage textures and adjacent lower surface elevations), and use of an associated method with such a sequence of movement carried out using such a massage device, can facilitate improved therapeutic effects at tissue (e.g., soft tissue of the foot) in a cost-effective and efficient manner.

One embodiment includes a massage device. This massage device includes a body, a first end portion of the body, a second end portion of the body, and an intermediate portion of the body. The body defines a central longitudinal axis, and the body defines a width in a direction transverse to the central longitudinal axis. The first end portion of the body includes a first plurality of massage textures that extend out from the first end portion of the body and a first plurality of lower surface elevations adjacent the first plurality of massage textures. The first end portion of the body defines a first end portion first width, in the direction transverse to the central longitudinal axis, at the first plurality of massage textures and a first end portion second width, in the direction transverse to the central longitudinal axis, at the first plurality of lower surface elevations, where the first end portion first width is greater than the first end portion second width. The second end portion of the body includes a second plurality of massage textures that extend out from the second end portion of the body and a second plurality of lower surface elevations adjacent the second plurality of massage textures. The second end portion of the body defines a second end portion first width, in the direction transverse to the central longitudinal axis, at the second plurality of massage textures and a second end portion second width, in the direction transverse to the central longitudinal axis, at the second plurality of lower surface elevations, where the second end portion first width is greater than the second end portion second width. The intermediate portion of the body is located along the central longitudinal axis between the first end portion of the body and the second end portion of the body. The intermediate portion of the body includes a third plurality of massage textures that extend out from the intermediate portion of the body and a third plurality of lower surface elevations adjacent the third plurality of massage textures. The intermediate portion of the body defines an intermediate portion first width, in the direction transverse to the central longitudinal axis, at the third plurality of massage textures and an intermediate portion second width, in the direction transverse to the central longitudinal axis, at the third plurality of lower surface elevations, where the intermediate portion first width is greater than the intermediate portion second width. And, the intermediate portion first width is greater than each of the first end portion first width and the second end portion first width.

In a further embodiment of this massage device, the body is ovoid shaped.

In a further embodiment of this massage device, the body is oval shaped.

In a further embodiment of this massage device, each of the first plurality of massage textures defines a first apex that defines the first end portion first width, each of the second plurality of massage textures defines a second apex that defines the second end portion first width, and each of the third plurality of massage textures defines a third apex that defines the intermediate portion first width. In one such example, the first apex of each of the first plurality of massage textures, the second apex of each of the second plurality of massage textures, and the third apex each of the third plurality of massage textures defines an ovoid shaped profile interconnecting each of the first apex of each of the first plurality of massage textures, the second apex of each of the second plurality of massage textures, and the third apex each of the third plurality of massage textures. In another such example, the first apex of each of the first plurality of massage textures, the second apex of each of the second plurality of massage textures, and the third apex each of the third plurality of massage textures define an oval shaped profile interconnecting each of the first apex of each of the first plurality of massage textures, the second apex of each of the second plurality of massage textures, and the third apex each of the third plurality of massage textures.

In a further embodiment of this massage device, the intermediate portion of the body includes a central location along the central longitudinal axis. In one such example, the intermediate portion first width is included at the central location along the central longitudinal axis.

In a further embodiment of this massage device, at least some of the first plurality of massage textures and the first plurality of lower surface elevations are aligned at a first common elevation along the central longitudinal axis. In one such example, at least some of the second plurality of massage textures and the second plurality of lower surface elevations are aligned at a second common elevation along the central longitudinal axis, and at least some of the third plurality of massage textures and the third plurality of lower surface elevations are aligned at a third common elevation along the central longitudinal axis, where the first common elevation, the second common elevation, and the third common elevation are each at different locations along the central longitudinal axis.

In a further embodiment of this massage device, the first plurality of massage textures includes a first subgroup of the first plurality of massage textures having a first length in a direction transverse to each of the central longitudinal axis and the first end portion first width and a second subgroup of the first plurality of massage textures having a second length in a direction transverse to each of the central longitudinal axis and the first end portion first width, and wherein the first length is greater than the second length.

An additional embodiment includes a method of using a massage device. This method embodiments includes the step of moving an appendage along a first end portion of a body of the massage device. The body defines a central longitudinal axis and a width in a direction transverse to the central longitudinal axis. The first end portion of the body includes a first plurality of massage textures that extend out from the first end portion of the body and a first plurality of lower surface elevations adjacent the first plurality of massage textures. The first end portion of the body defines a first end portion first width, in the direction transverse to the central longitudinal axis, at the first plurality of massage textures and a first end portion second width, in the direction transverse to the central longitudinal axis, at the first plurality of lower surface elevations, where the first end portion first width is greater than the first end portion second width. This method embodiment also includes the step of moving the appendage along a second end portion of the body of the massage device. The second end portion of the body includes a second plurality of massage textures that extend out from the second end portion of the body and a second plurality of lower surface elevations adjacent the second plurality of massage textures. The second end portion of the body defines a second end portion first width, in the direction transverse to the central longitudinal axis, at the second plurality of massage textures and a second end portion second width, in the direction transverse to the central longitudinal axis, at the second plurality of lower surface elevations, where the second end portion first width is greater than the second end portion second width. This method embodiment further includes the step of moving the appendage along an intermediate portion of the body of the massage device. The intermediate portion is located along the central longitudinal axis between the first end portion of the body and the second end portion of the body, and the intermediate portion includes a third plurality of massage textures that extend out from the intermediate portion of the body and a third plurality of lower surface elevations adjacent the third plurality of massage textures. The intermediate portion of the body defines an intermediate portion first width, in the direction transverse to the central longitudinal axis, at the third plurality of massage textures and an intermediate portion second width, in the direction transverse to the central longitudinal axis, at the third plurality of lower surface elevations, where the intermediate portion first width is greater than the intermediate portion second width. And, the intermediate portion first width is greater than each of the first end portion first width and the second end portion first width.

In a further embodiment of this method, the appendage is a foot. In one such example, a plantar fascia of the foot is moved along the first end portion of the body, the second end portion of the body, and the intermediate portion of the body. For instance, the foot can be placed into contact with the body and the plantar fascia can be moved over the first plurality of massage textures, the second plurality of massage textures, and the third plurality of massage textures. This can include the plantar fascia being moved over one of the first plurality of massage textures and the second plurality of massage textures before the plantar fascia is moved over the third plurality of massage textures. Additionally or alternatively, this can include the plantar fascia being moved over the third plurality of massage textures before the plantar fascia is moved over one of the first plurality of massage textures and the second plurality of massage textures.

In a further embodiment of this method, while the appendage is moved along the intermediate portion of the body, the appendage diverges outward from the central longitudinal axis. Additionally or alternatively, while the appendage is moved along at least one of the first end portion of the body and the second end portion of the body, the appendage encroaches inward toward the central longitudinal axis.

In a further embodiment of this method, the body is one of oval and ovoid shaped.

Another embodiment includes a massage device. This massage device embodiment includes a body, a first outer surface, and a plurality of protuberances. The body defines a central longitudinal axis. The body also defines a length in a direction parallel to the central longitudinal axis and a width in a direction transverse to the central longitudinal axis, with the length being greater than the width. The first outer surface of the body gives the body an oval or ovoid profile with the length being greater than the width. The plurality of protuberances extend outward away from the first outer surface, and the plurality of protuberances form massage textures located adjacent to portions of the first outer surface located inward of the protuberances.

The details of one or more examples are set forth in the accompanying drawings and the description below. Other features, objects, and advantages will be apparent from the description and drawings.

### BRIEF DESCRIPTION OF THE DRAWINGS

The following drawings are illustrative of particular embodiments of the present invention and, therefore, do not limit the scope of the invention. The drawings are intended for use in conjunction with the explanations in the following description. Embodiments of the invention will hereinafter be described in conjunction with the appended drawings, wherein like numerals denote like elements. The features illustrated in the drawings are not necessarily to scale, though embodiments within the scope of the present invention can include one or more of the illustrated features (e.g., each of the illustrated features) at the scale shown.

FIG. 1 is a perspective view of an embodiment of a massage device.

FIG. 2 is a side elevational view of one side of the massage device of FIG. 1.

FIG. 3 is a side elevational view of another side, adjacent the side shown at FIG. 2, of the massage device of FIG. 1.

FIG. 4 is a perspective view of another embodiment of a massage device.

FIG. 5 is a side elevational view of one side of the massage device of FIG. 4.

FIG. 6 is a side elevational view of another side, adjacent the side shown at FIG. 5, of the massage device of FIG. 4.

FIG. 7 is an elevational view of an additional embodiment of a massage device.

FIG. 8 is a flow diagram of an embodiment of a method of using a massage device.

### DETAILED DESCRIPTION

The following detailed description is exemplary in nature and is not intended to limit the scope, applicability, or configuration of the invention in any way. Rather, the following description provides some practical illustrations for implementing embodiments of the present invention. Examples of constructions, materials, and/or dimensions are provided for selected elements. Those skilled in the art will recognize that many of the noted examples have a variety of suitable alternatives.

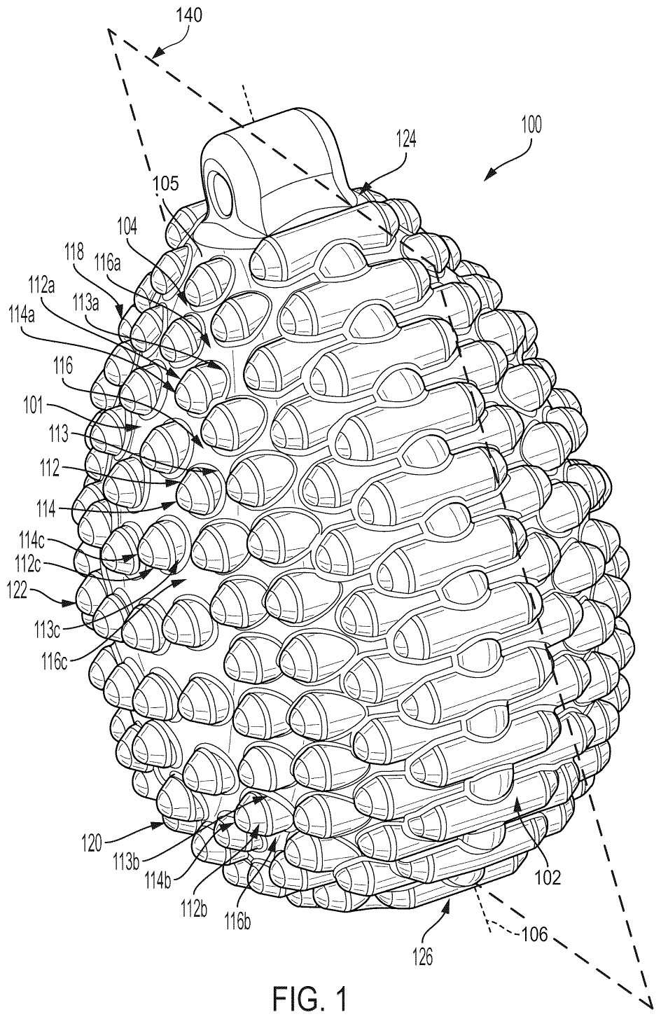

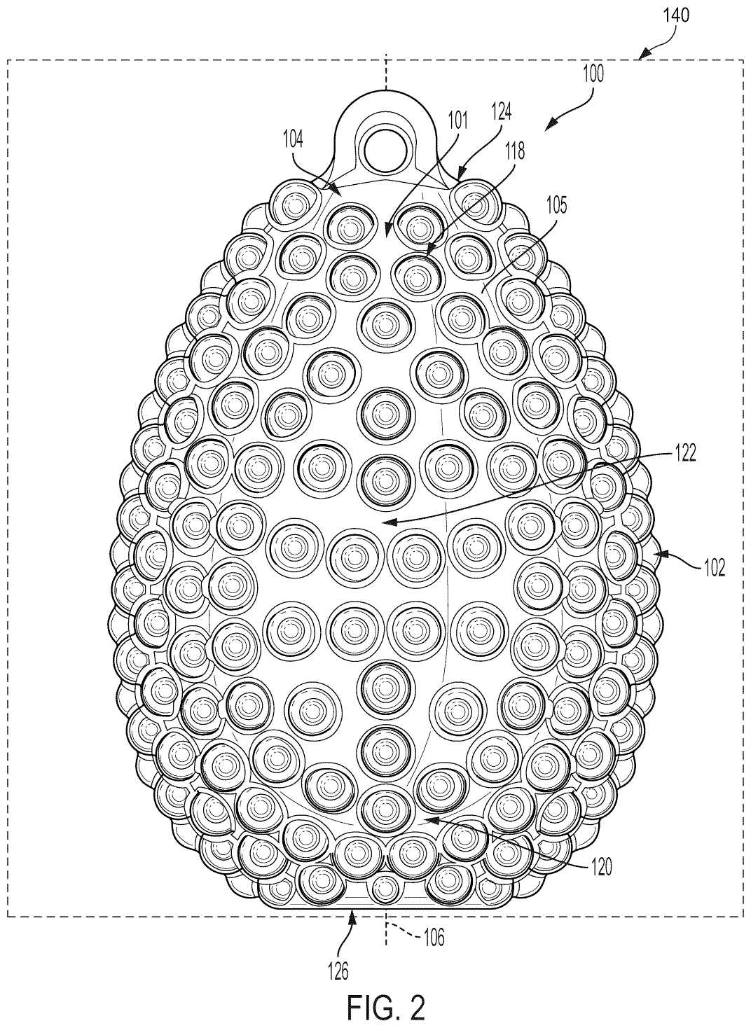

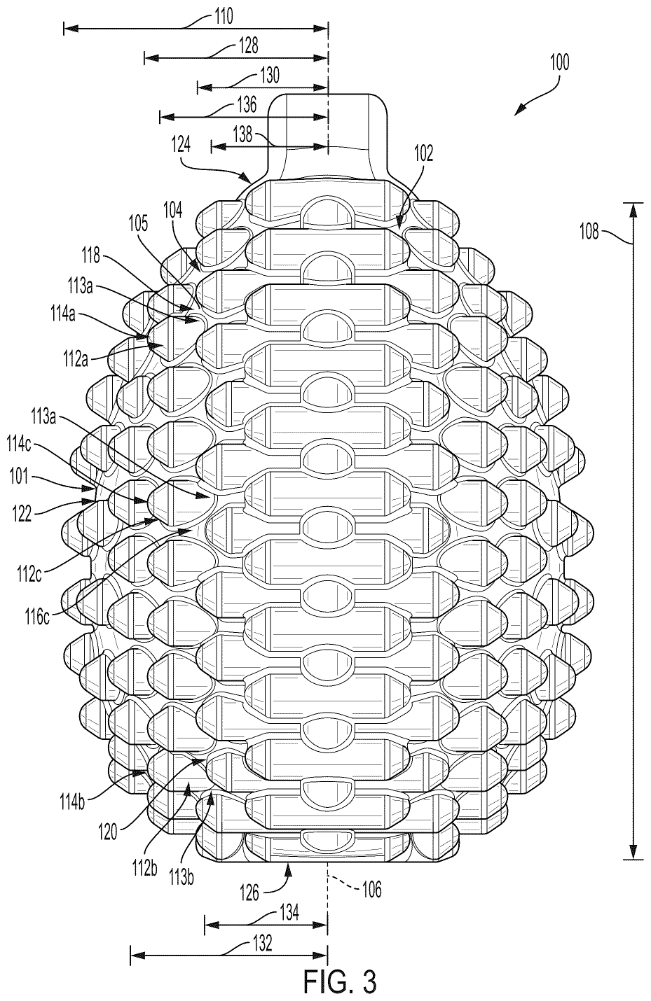

FIGS. 1-3 illustrate an exemplary embodiment of a massage device 100. FIG. 1 is a perspective view of the massage device 100, FIG. 2 is a side elevational view of one side 101 of the massage device 100, and FIG. 3 is a side elevational view of another side 102, adjacent the side 101, of the massage device 100.

The massage device 100 can include a body 104. The body 104 can define a central longitudinal axis 106, and the body can define a length 108 in a direction parallel to the central longitudinal axis 106 and a width 110 in a direction transverse to the central longitudinal axis 106. In the example illustration, the width 110 is shown as measured from the central longitudinal axis 106 to a maximum extent (e.g., at an apex of a massage texture) of the massage device 100 in the direction transverse to the central longitudinal axis 106, though in other embodiments the width 110 defined by the body 104 can be measured using other reference points, such as from a maximum extent (e.g., at an apex of a massage texture) at one side of the massage device 100 in the direction transverse to the central longitudinal axis 106 to a maximum extent (e.g., at an apex of another massage texture) at another, opposite side of the massage device 100 in the direction transverse to the central longitudinal axis 106. For the embodiment of the massage device 100 illustrated here, the length 108 is greater than the width 110.

The body 104 can include an outer surface 105. For the illustrated embodiment, the body 104 is ovoid shaped. In particular, for example, the outer surface 105, of the body 104 of the massage device 100, is contoured so as to give the body 104 an ovoid profile as defined by the outer surface 105. As shown here, the length 108 of the ovoid profile defined by the outer surface 105 can be greater than the width 110 of the ovoid profile defined by the outer surface 105. The body 104 can also include a plurality of protuberances each of which can define a massage texture 112. The plurality of protuberances, each defining a corresponding massage texture 112, can extend outward away from the outer surface 105.

In the embodiment illustrated in FIGS. 1-3, the plurality of protuberances extend in a direction normal to, and on either side of, a central plane 140. The central plane 140 extends through the longest dimension of the body 104, which in the illustrated embodiment is along the central longitudinal axis 106, and includes a first side and a second side. The second side of the central plane 140 is opposite the first side of the central plane. As illustrated, a first plurality of protuberances (e.g., those leftward of the central plane 140) can extend in a direction normal to the first side of the central plane while a second plurality of protuberances (e.g., those rightward of the central plane 140) can extend in a direction normal to the second side of the central plane. In such a configuration, the first plurality of protuberances extend in a direction opposite the second plurality of protuberances and can be considered mirror images of the second plurality of protuberances about the central plane 140.

The plurality of protuberances, each defining a corresponding massage texture 112, can include a massage texture base 113 of the massage texture 112 and a massage texture apex 114 of the massage texture 112, with the massage texture base 113 at the outer surface 105 and the massage texture apex 114 at an end of the massage texture 112 opposite the massage texture base 113, such that the massage texture apex 114 can define a portion of the massage texture 112 furthest from the outer surface 105. Additionally, the body 104 can include portions of the outer surface 105 located inward of the protuberances with such portions defining a plurality of lower surface elevations 116, with the plurality of lower surface elevations 116 location adjacent the plurality of protuberances that define the plurality of massage textures 112.

The body 104 can include a first end portion 118, a second end portion 120, and an intermediate portion 122. The intermediate portion 122 of the body 104 can be disposed between the first end portion 118 and the second end portion 120 such that the intermediate portion 122 is located along the central longitudinal axis 106 between a location of the first end portion 118 along the central longitudinal axis 106 and a location of the second end portion 120 along the central longitudinal axis 106. Notably, for the illustrated embodiment of the massage device 100, the intermediate portion 122 can have a greatest width 110 of the body 104 and each of the first end portion 118 and the second end portion 120 can have lesser width 110 of the body 104 than that of the intermediate portion 122. Accordingly, in this embodiment, when moving an appendage (e.g., foot) in a direction between one end 124 (e.g., a top end) of the massage device 100 and another end 126 (e.g., a bottom end) of the massage device 100 opposite the end 124 along the central longitudinal axis 106, the appendage can move outward away from the central longitudinal axis 106 as the appendage is moved along and from one of the first and second end portions 118, 120 toward the intermediate portion 122 and the appendage can move inward toward the central longitudinal axis 106 as the appendage is moved from the intermediate portion 122 toward one of the first and second end portions 118, 120.

The first end portion 118 of the body 104 can include a first plurality of massage textures 112a and a first plurality of lower surface elevations 116a that are adjacent the first plurality of massage textures 112a. Each of the first plurality of massage textures 112a can extend out from the first end portion 118 of the body 104, such as in a direction generally transverse to the central longitudinal axis 106 (e.g., perpendicular to the central plane 140). For instance, each of the first plurality of massage textures 112a can include a massage texture base 113a, at the outer surface 105, and a massage texture apex 114a at an end of the massage texture 112a opposite the outer surface 105. The first end portion 118 of the body 104 can define a first end portion first width 128, in the direction transverse to the central longitudinal axis 106, at the first plurality of massage textures 112a and a first end portion second width 130, in the direction transverse to the central longitudinal axis 106, at the first plurality of lower surface elevations 116a. And, the first end portion first width 128 can be greater than the first end portion second width 130.

The second end portion 120 of the body 104 can include a second plurality of massage textures 112b and a second plurality of lower surface elevations 116b that are adjacent the second plurality of massage textures 112b. Each of the second plurality of massage textures 112b can extend out from the second end portion 120 of the body 104, such as in a direction generally transverse to the central longitudinal axis 106 (e.g., perpendicular to the central plane 140). For instance, each of the second plurality of massage textures 112b can include a massage texture base 113b, at the outer surface 105, and a massage texture apex 114b at an end of the massage texture 112b opposite the outer surface 105. The second end portion 120 of the body 104 can define a second end portion first width 132, in the direction transverse to the central longitudinal axis 106, at the second plurality of massage textures 112b and a second end portion second width 134, in the direction transverse to the central longitudinal axis 106, at the second plurality of lower surface elevations 116b. And, the second end portion first width 132 can be greater than the second end portion second width 134.

The intermediate portion 122 of the body 104 can include a third plurality of massage textures 112c and a third plurality of lower surface elevations 116c that are adjacent the third plurality of massage textures 112c. Each of the third plurality of massage textures 112c can extend out from the intermediate portion 122 of the body 104, such as in a direction generally transverse to the central longitudinal axis 106 (e.g., perpendicular to the central plane 140). For instance, each of the third plurality of massage textures 112c can include a massage texture base 113c, at the outer surface 105, and a massage texture apex 114c at an end of the massage texture 112c opposite the outer surface 105. The intermediate portion 122 of the body 104 can define an intermediate portion first width 136, in the direction transverse to the central longitudinal axis 106, at the third plurality of massage textures 112c and an intermediate portion second width 138, in the direction transverse to the central longitudinal axis 106, at the third plurality of lower surface elevations 116c. And, the intermediate portion first width 136 can be greater than the intermediate portion second width 138. In some embodiments, the intermediate portion 122 of the body 104 can include a central location along the central longitudinal axis 106, and, in a further such embodiment, the intermediate portion first width 136 can be included at this central location along the central longitudinal axis 106.

The massage device 100 can include the intermediate portion 122 defining a greater extent, and thus greater width 110, of the body 104 than each of the first and second end portions 118, 120. For instance, for each of a massage texture 112a at the first end portion 118, a massage texture 112b at the second end portion 120, and a massage texture 112c at the intermediate portion 122 at a generally common location aligned along the central longitudinal axis 106, the massage device 100 can include the intermediate portion first width 136 as greater than each of the first end portion first width 128 and the second end portion first width 132. In such an embodiment, an apex 114c of a massage texture 112c at the intermediate portion 122 can be located further out from the central longitudinal axis 106 than each of an apex 114a of a massage texture 112a at the first end portion 118 and an apex 114b of a massage texture 112b at the second end portion 120 (e.g., where the massage textures 112a, 112b are at a location aligned along an axis running parallel to the central longitudinal axis 106).

In one example, each of the first plurality of massage textures 112a can define a first apex 114a that defines the first end portion first width 128, each of the second plurality of massage textures 112b can define a second apex 114b that defines the second end portion first width 132, and each of the third plurality of massage textures 112c can define a third apex 114c that defines the intermediate portion first width 136. In such an example, it can be that the first apex 114a of each of the first plurality of massage textures 112a, the second apex 114b of each of the second plurality of massage textures 112b, and the third apex 114c each of the third plurality of massage textures 112c define an ovoid shaped profile, with this ovoid shaped profile interconnecting each of the first apex 114a of each of the first plurality of massage textures 112a, the second apex 114b of each of the second plurality of massage textures 112b, and the third apex 114c each of the third plurality of massage textures 112c.

In some embodiments within the scope of this disclosure, such as the illustrated embodiment of the massage device 100, at least some of the plurality of massage textures 112 and the lower surface elevations 116 can be aligned at a common elevation along the central longitudinal axis 106. For example, at least some of the first plurality of massage textures 112a and the first plurality of lower surface elevations 116a can be aligned at a first common elevation along the central longitudinal axis 106, at least some of the second plurality of massage textures 112b and the second plurality of lower surface elevations 116b can be aligned at a second common elevation along the central longitudinal axis 106, and/or at least some of the third plurality of massage textures 112c and the third plurality of lower surface elevations 116c can be aligned at a third common elevation along the central longitudinal axis 106, where the first common elevation, the second common elevation, and the third common elevation are each at different elevational locations along the central longitudinal axis 106.

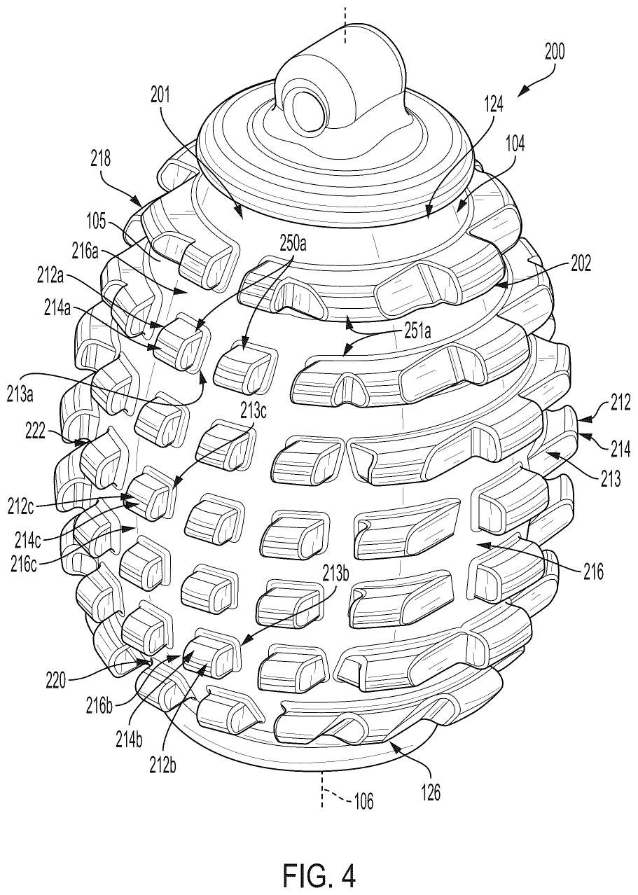

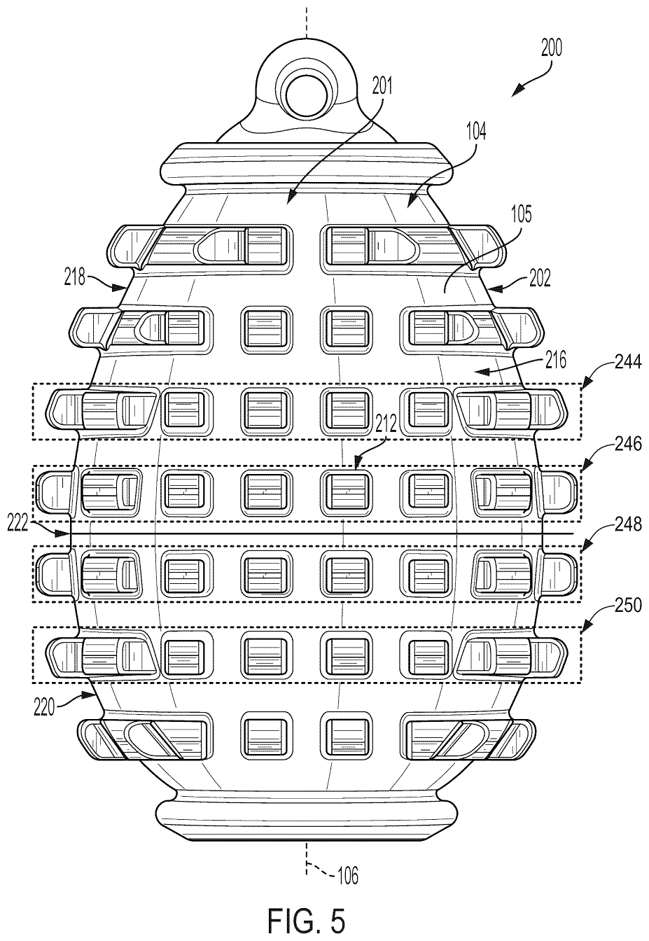

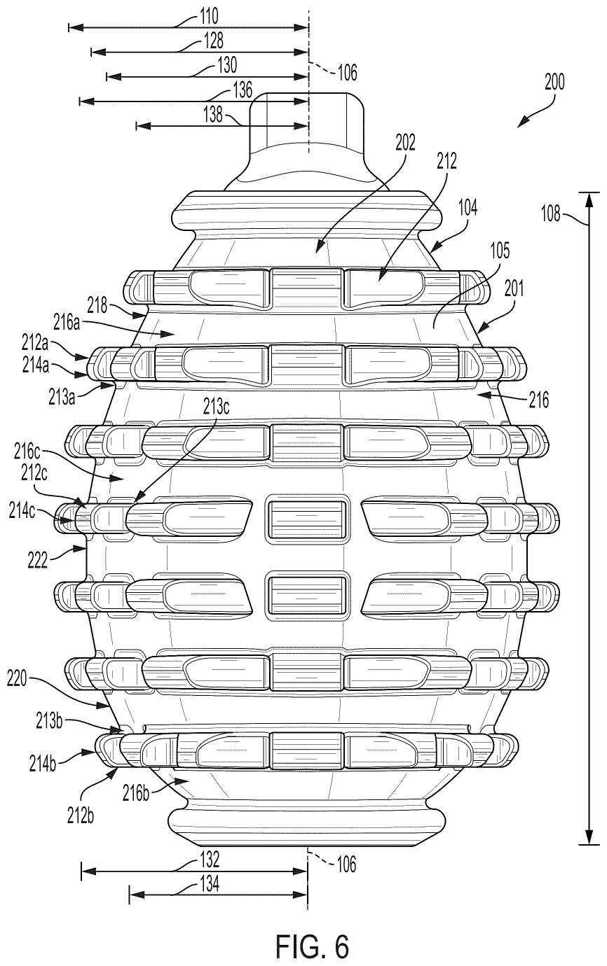

FIGS. 4-6 illustrate another exemplary embodiment of a massage device 200. FIG. 4 is a perspective view of the massage device 200, FIG. 5 is a side elevational view of one side 201 of the massage device 200, and FIG. 6 is a side elevational view of another side 202, adjacent the side 201, of the massage device 200. The massage device 200 can be similar to, or the same as, the massage device 100 previously disclosed herein except, for instance, as otherwise noted here. As one example, the massage device 200 can be similar to, or the same as, the massage device 100 (including that each can, in some cases, have an ovoid shaped body) except that the massage device 200 includes massage textures of a different geometry than the massage textures of the massage device 100.

The massage device 200 can include the body 104. The body 104 can define the central longitudinal axis 106, and the body 104 can define the length 108 in a direction parallel to the central longitudinal axis 106 and the width 110 in a direction transverse to the central longitudinal axis 106. In the example illustration, the width 110 is shown as measured from the central longitudinal axis 106 to a maximum extent (e.g., at an apex of a massage texture) of the massage device 200 in the direction transverse to the central longitudinal axis 106, though in other embodiments the width 110 defined by the body 104 can be measured using other reference points, such as from a maximum extent (e.g., at an apex of a massage texture) at one side of the massage device 200 in the direction transverse to the central longitudinal axis 106 to a maximum extent (e.g., at an apex of another massage texture) at another, opposite side of the massage device 200 in the direction transverse to the central longitudinal axis 106. For the embodiment of the massage device 200 illustrated here, the length 108 is greater than the width 110.

As with the previously described embodiment of the massage device 100, for the massage device 200 the body 104 can include the outer surface 105. For the illustrated embodiment of the massage device 200, the body 104 is ovoid shaped. In particular, for example, the outer surface 105, of the body 104 of the massage device 100, is contoured so as to give the body 104 an ovoid profile as defined by the outer surface 105. As shown here, the length 108 of the ovoid profile defined by the outer surface 105 can be greater than the width 110 of the ovoid profile defined by the outer surface 105. The body 104 can also include a plurality of protuberances each of which can define a massage texture 212. The plurality of protuberances, each defining a corresponding massage texture 212, can extend outward away from the outer surface 105. As such, the plurality of protuberances, each defining a corresponding massage texture 212, can include a massage texture base 213 of the massage texture 212 and a massage texture apex 214 of the massage texture 212, with the massage texture base 213 at the outer surface 105 and the massage texture apex 214 at an end of the massage texture 212 opposite the massage texture base 213, such that the massage texture apex 214 can define a portion of the massage texture 212 furthest from the outer surface 105. Additionally, the body 104 can include portions of the outer surface 105 located inward of the protuberances with such portions defining a plurality of lower surface elevations 216, with the plurality of lower surface elevations 216 location adjacent the plurality of protuberances that define the plurality of massage textures 212.

The body 104 can include the first end portion 218, the second end portion 220, and the intermediate portion 222. The intermediate portion 222 of the body 104 can be disposed between the first end portion 218 and the second end portion 220 such that the intermediate portion 222 is located along the central longitudinal axis 106 between a location of the first end portion 218 along the central longitudinal axis 106 and a location of the second end portion 220 along the central longitudinal axis 106. Notably, for the illustrated embodiment of the massage device 200, the intermediate portion 222 can have a greatest width 110 of the body 104 and each of the first end portion 218 and the second end portion 220 can have lesser width 110 of the body 104 than that of the intermediate portion 222. Accordingly, in this embodiment, when moving an appendage (e.g., foot) in a direction between one end 124 (e.g., a top end) of the massage device 100 and another end 126 (e.g., a bottom end) of the massage device 200 opposite the end 124 along the central longitudinal axis 106, the appendage can move outward away from the central longitudinal axis 106 as the appendage is moved along and from one of the first and second end portions 218, 220 toward the intermediate portion 222 and the appendage can move inward toward the central longitudinal axis 106 as the appendage is moved from the intermediate portion 222 toward one of the first and second end portions 218, 220.

The first end portion 218 of the body 104 can include a first plurality of massage textures 212a and a first plurality of lower surface elevations 216a that are adjacent the first plurality of massage textures 212a. Each of the first plurality of massage textures 212a can extend out from the first end portion 218 of the body 104, such as in a direction generally transverse to the central longitudinal axis 106 (e.g., outward from the body 104). For instance, each of the first plurality of massage textures 212a can include a massage texture base 213a, at the outer surface 105, and a massage texture apex 214a at an end of the massage texture 212a opposite the outer surface 105. The first end portion 218 of the body 104 can define the first end portion first width 128, in the direction transverse to the central longitudinal axis 106, at the first plurality of massage textures 212a and a first end portion second width 130, in the direction transverse to the central longitudinal axis 106, at the first plurality of lower surface elevations 216a. And, the first end portion first width 128 can be greater than the first end portion second width 130.

The second end portion 220 of the body 104 can include a second plurality of massage textures 212b and a second plurality of lower surface elevations 216b that are adjacent the second plurality of massage textures 212b. Each of the second plurality of massage textures 212b can extend out from the second end portion 220 of the body 104, such as in a direction generally transverse to the central longitudinal axis 106 (e.g., outward from the body 104). For instance, each of the second plurality of massage textures 212b can include a massage texture base 213b, at the outer surface 105, and a massage texture apex 214b at an end of the massage texture 212b opposite the outer surface 105. The second end portion 220 of the body 104 can define a second end portion first width 132, in the direction transverse to the central longitudinal axis 106, at the second plurality of massage textures 212b and a second end portion second width 134, in the direction transverse to the central longitudinal axis 106, at the second plurality of lower surface elevations 216b. And, the second end portion first width 132 can be greater than the second end portion second width 134.

The intermediate portion 222 of the body 104 can include a third plurality of massage textures 212c and a third plurality of lower surface elevations 216c that are adjacent the third plurality of massage textures 212c. Each of the third plurality of massage textures 212c can extend out from the intermediate portion 222 of the body 104, such as in a direction generally transverse to the central longitudinal axis 106 (e.g., outward from the body 104). For instance, each of the third plurality of massage textures 212c can include a massage texture base 213c, at the outer surface 105, and a massage texture apex 214c at an end of the massage texture 212c opposite the outer surface 105. The intermediate portion 222 of the body 104 can define an intermediate portion first width 136, in the direction transverse to the central longitudinal axis 106, at the third plurality of massage textures 212c and an intermediate portion second width 138, in the direction transverse to the central longitudinal axis 106, at the third plurality of lower surface elevations 216c. And, the intermediate portion first width 136 can be greater than the intermediate portion second width 138. In some embodiments, the intermediate portion 222 of the body 104 can include a central location along the central longitudinal axis 106, and, in a further such embodiment, the intermediate portion first width 136 can be included at this central location along the central longitudinal axis 106.

The massage device 200 can include the intermediate portion 222 defining a greater extent, and thus greater width 110, of the body 104 than each of the first and second end portions 218, 220. For instance, for each of a massage texture 212a at the first end portion 218, a massage texture 212b at the second end portion 220, and a massage texture 212c at the intermediate portion 222 at a generally common location aligned along the central longitudinal axis 106, the massage device 200 can include the intermediate portion first width 136 as greater than each of the first end portion first width 128 and the second end portion first width 132. In such an embodiment, an apex 214c of a massage texture 212c at the intermediate portion 222 can be located further out from the central longitudinal axis 106 than each of an apex 214a of a massage texture 212a at the first end portion 218 and an apex 214b of a massage texture 212b at the second end portion 220 (e.g., where the massage textures 212a, 212b are at a location aligned along an axis running parallel to the central longitudinal axis 106).

In one example, each of the first plurality of massage textures 212a can define a first apex 214a that defines the first end portion first width 128, each of the second plurality of massage textures 212b can define a second apex 214b that defines the second end portion first width 132, and each of the third plurality of massage textures 212c can define a third apex 214c that defines the intermediate portion first width 136. In such an example, it can be that the first apex 214a of each of the first plurality of massage textures 212a, the second apex 214b of each of the second plurality of massage textures 212b, and the third apex 214c each of the third plurality of massage textures 212c define an ovoid shaped profile, with this ovoid shaped profile interconnecting each of the first apex 214a of each of the first plurality of massage textures 212a, the second apex 214b of each of the second plurality of massage textures 212b, and the third apex 214c each of the third plurality of massage textures 212c.

In some embodiments within the scope of this disclosure, such as the illustrated embodiment of the massage device 200, at least some of the plurality of massage textures 212 and the lower surface elevations 216 can be aligned at a common elevation along the central longitudinal axis 106. For example, at least some of the first plurality of massage textures 212a and the first plurality of lower surface elevations 216a can be aligned at a first common elevation along the central longitudinal axis 106, at least some of the second plurality of massage textures 212b and the second plurality of lower surface elevations 216b can be aligned at a second common elevation along the central longitudinal axis 106, and/or at least some of the third plurality of massage textures 212c and the third plurality of lower surface elevations 216c can be aligned at a third common elevation along the central longitudinal axis 106, where the first common elevation, the second common elevation, and the third common elevation are each at different elevational locations along the central longitudinal axis 106.

In some embodiments, each of the common elevations can represent a row of massage textures and/or protuberances. For example, as illustrated in FIG. 5, the massage device includes multiple rows of protuberances including a first row 244 of protuberances, a second row 246 of protuberances, a third row 248 of protuberances, and a fourth row 250 of protuberances. Each of the first row 244, the second row 246, the third row 248, and the fourth row 250 are at a respective location spaced along the central axis 106. The rows can extend perpendicular to, or approximately perpendicular to (e.g., within +/−15 degrees), the central longitudinal axis 106. In some embodiments, each row is evenly spaced apart from each other row. For example, the first row 244 of protuberances is spaced apart from the second row 246 of protuberances the same longitudinal distance as the second row 246 of protuberances is spaced apart from the third row 248 of protuberances. However, in some examples, one or more of the rows are spaced apart from other rows by different distances. For instance, a first row may be spaced apart a different longitudinal distance from the second row as the second row is spaced apparat from the third row. In the illustrated embodiment of FIGS. 4-6, the massage device 200 includes seven rows of protuberances. In some examples, more or fewer numbers of rows may be used (e.g., 4 or more).

In some embodiments, one or more rows of protuberances can be symmetrical about a plane extending perpendicular to the longitudinal axis 106. In some such embodiments, the plane extends perpendicular to the longitudinal axis 106 at a point defined by the intermediate portion 222 (e.g., the widest part of the massage device). For example, as illustrated in FIG. 5, the second row 246 is symmetrical to the third row 248 and the first row is symmetrical to the fourth row 250 about a plane defined by the intermediate portion 222. In some examples, other rows can also be symmetrical across the plane defined by the intermediate portion 222.

The massage device 200 can include massage textures 212 of differing dimensions relative to one another. For example, the massage device 200 can include massage textures 212 having different lengths, such as differing lengths in a direction transverse to each of the central longitudinal axis 106. As one specific such example, the first plurality of massage textures 212a can include a first subgroup 251a of the first plurality of massage textures 212a having a first length in a direction transverse to each of the central longitudinal axis 106 and the first end portion first width 128 and a second subgroup 250a of the first plurality of massage textures 212a having a second length in a direction transverse to each of the central longitudinal axis 106 and the first end portion first width 128, with the first length being greater than the second length.

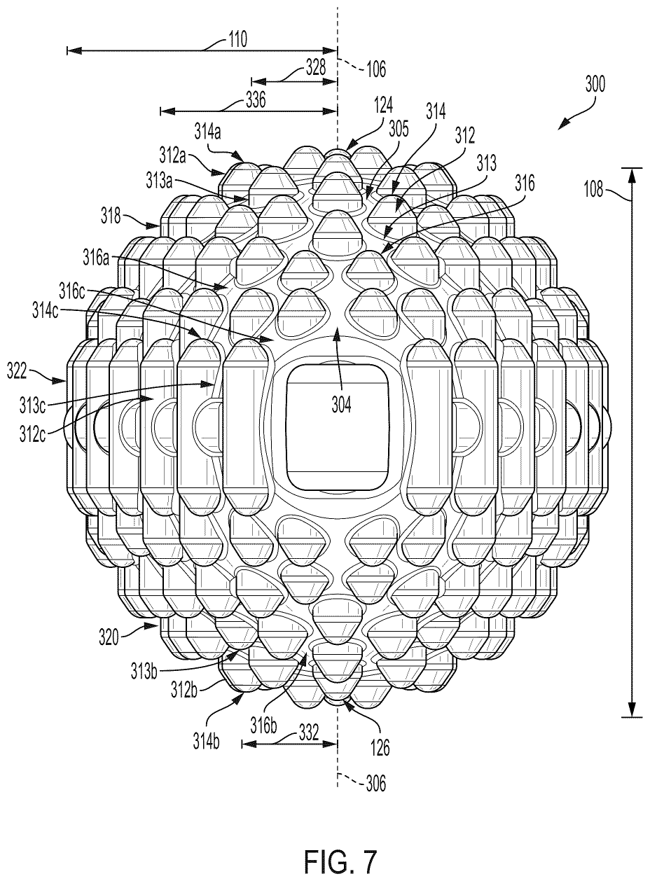

FIG. 7 illustrates an elevational view of an additional embodiment of a massage device 300. The massage device 300 can be similar to, or the same as, the massage device 100 and/or the massage device 200 previously disclosed herein except, for instance, as otherwise noted here. As one example, the massage device 300 can be similar to, or the same as, the massage device 100 and/or the massage device 200 except that the massage device 300 can have an oval shaped body.

The device 300 massage device 100 can include a body 304. The body 304 can define a central longitudinal axis 306, and the body 304 can define the length 108 in a direction parallel to the central longitudinal axis 306 and the width 110 in a direction transverse to the central longitudinal axis 306. In the example illustration, the width 110 is shown as measured from the central longitudinal axis 306 to a maximum extent (e.g., at an apex of a massage texture) of the massage device 300 in the direction transverse to the central longitudinal axis 306. For the embodiment of the massage device 300 illustrated here, the length 108 can be equal to or greater than the width 110.

The body 304 can include an outer surface 305. For the illustrated embodiment, the body 304 is oval shaped. In particular, for example, the outer surface 305, of the body 304 of the massage device 300, is contoured so as to give the body 304 an oval profile as defined by the outer surface 305. For example, the length 108 of the oval profile defined by the outer surface 305 can be generally equal to the width 110 of the oval profile defined by the outer surface 305. The body 304 can also include a plurality of protuberances each of which can define a massage texture 312. The plurality of protuberances, each defining a corresponding massage texture 312, can extend outward away from the outer surface 305. As such, the plurality of protuberances, each defining a corresponding massage texture 312, can include a massage texture base 313 of the massage texture 312 and a massage texture apex 314 of the massage texture 312, with the massage texture base 313 at the outer surface 305 and the massage texture apex 314 at an end of the massage texture 312 opposite the massage texture base 313, such that the massage texture apex 314 can define a portion of the massage texture 312 furthest from the outer surface 305. Additionally, the body 304 can include portions of the outer surface 305 located inward of the protuberances with such portions defining a plurality of lower surface elevations 316, with the plurality of lower surface elevations 316 location adjacent the plurality of protuberances that define the plurality of massage textures 312.

The body 304 can include a first end portion 318, a second end portion 320, and an intermediate portion 322. The intermediate portion 322 of the body 304 can be disposed between the first end portion 318 and the second end portion 320 such that the intermediate portion 322 is located along the central longitudinal axis 306 between a location of the first end portion 318 along the central longitudinal axis 306 and a location of the second end portion 320 along the central longitudinal axis 306. Notably, for the illustrated embodiment of the massage device 300, the intermediate portion 322 can have a greatest width 110 of the body 304 and each of the first end portion 318 and the second end portion 320 can have lesser width 110 of the body 304 than that of the intermediate portion 322. Accordingly, in this embodiment, when moving an appendage (e.g., foot) in a direction between one end 124 (e.g., a top end) of the massage device 300 and another end 126 (e.g., a bottom end) of the massage device 300 opposite the end 124 along the central longitudinal axis 306, the appendage can move outward away from the central longitudinal axis 306 as the appendage is moved along and from one of the first and second end portions 318, 320 toward the intermediate portion 322 and the appendage can move inward toward the central longitudinal axis 306 as the appendage is moved from the intermediate portion 322 toward one of the first and second end portions 318, 320.

The first end portion 318 of the body 304 can include a first plurality of massage textures 312a and a first plurality of lower surface elevations 316a that are adjacent the first plurality of massage textures 312a. Each of the first plurality of massage textures 312a can extend out from the first end portion 318 of the body 304, such as in a direction generally parallel to the central longitudinal axis 306. For instance, each of the first plurality of massage textures 312a can include a massage texture base 313a, at the outer surface 305, and a massage texture apex 314a at an end of the massage texture 312a opposite the outer surface 305. The device 300 can have the first end portion 318 of the body 304 defining a first end portion first width 328, in the direction transverse to the central longitudinal axis 306, at any of the first plurality of massage textures 312a.

The second end portion 320 of the body 304 can include a second plurality of massage textures 312b and a second plurality of lower surface elevations 316b that are adjacent the second plurality of massage textures 312b. Each of the second plurality of massage textures 312b can extend out from the second end portion 320 of the body 304, such as in a direction generally parallel to the central longitudinal axis 306. For instance, each of the second plurality of massage textures 312b can include a massage texture base 313b, at the outer surface 305, and a massage texture apex 314b at an end of the massage texture 312b opposite the outer surface 305. The device 300 can have the second end portion 320 of the body 304 defining a second end portion first width 332, in the direction transverse to the central longitudinal axis 306, at any of the second plurality of massage textures 312b.

The intermediate portion 322 of the body 304 can include a third plurality of massage textures 312c and a third plurality of lower surface elevations 316c that are adjacent the third plurality of massage textures 312c. Each of the third plurality of massage textures 312c can extend out from the intermediate portion 322 of the body 304, such as in a direction generally parallel to the central longitudinal axis 306. For instance, each of the third plurality of massage textures 312c can include a massage texture base 313c, at the outer surface 305, and a massage texture apex 314c at an end of the massage texture 312c opposite the outer surface 305. The device 300 can have the intermediate portion 322 of the body 304 defining an intermediate portion first width 336, in the direction transverse to the central longitudinal axis 306, at any of the third plurality of massage textures 312c. In some embodiments, the intermediate portion 322 of the body 304 can include a central location along the central longitudinal axis 306, and, in a further such embodiment, the intermediate portion first width 336 can be included at this central location along the central longitudinal axis 306. For the illustrated embodiment of the massage device 300, at least some of the first plurality of massage textures 312a, the second plurality of massage textures 312b, and/or the third plurality of massage textures 312c can have a length, extending in a direction parallel to the central longitudinal axis 306, that is greater than a width, extending in a direction transverse to the central longitudinal axis 306. For instance, as illustrated for the massage device 300, at least some the massage textures 312c at the intermediate portion 322 can be longer, in a direction extending parallel to the central longitudinal axis 306, than at least some of the massage textures 312a, 312b at the first and second end portions 318, 320.

The massage device 300 can include the intermediate portion 322 defining a greater extent, and thus greater width 110, of the body 304 than each of the first and second end portions 318, 320. For instance, for each of a massage texture 312a at the first end portion 318, a massage texture 312b at the second end portion 320, and a massage texture 312c at the intermediate portion 322 at a generally common location aligned along the central longitudinal axis 306, the massage device 300 can include the intermediate portion first width 336 as greater than each of the first end portion first width 328 and the second end portion first width 332. In such an embodiment, a side end, opposite a side having the base 313c, of a massage texture 312c at the intermediate portion 322 can be located further out from the central longitudinal axis 306 than a side end, opposite a side having the base 313, 313b of each of a massage texture 312a at the first end portion 318 and a massage texture 312b at the second end portion 320 (e.g., where the massage textures 312a, 312b are at a location aligned along an axis running parallel to the central longitudinal axis 306).

In one example, each of the first plurality of massage textures 312a can define a first apex 314a, each of the second plurality of massage textures 312b can define a second apex 314b, and each of the third plurality of massage textures 312c can define a third apex 114c. In such an example, it can be that the first apex 314a of each of the first plurality of massage textures 312a, the second apex 314b of each of the second plurality of massage textures 312b, and the third apex 314c each of the third plurality of massage textures 312c define an oval shaped profile, with this oval shaped profile interconnecting each of the first apex 314a of each of the first plurality of massage textures 312a, the second apex 314b of each of the second plurality of massage textures 312b, and the third apex 314c each of the third plurality of massage textures 312c.

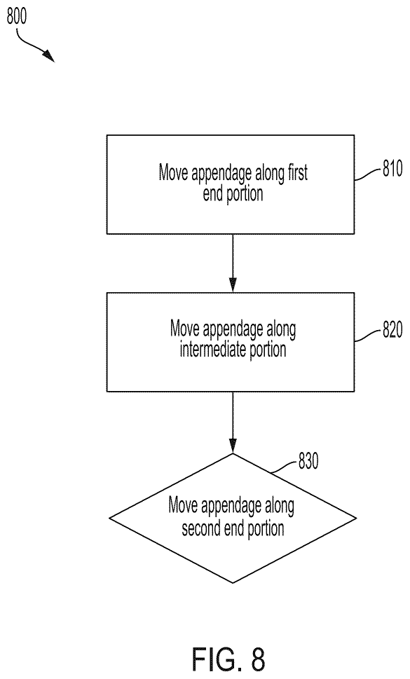

FIG. 8 is a flow diagram of an embodiment of a method 800 of using a massage device. For example, the method 800 can be carried out using any one or more of the massage device features disclosed elsewhere herein, including use of any one or more of the massage device embodiments disclosed elsewhere herein.

At step 810, the method 800 includes moving an appendage, such as a foot, along a first end portion of a body of the massage device. The body of the massage device can define a central longitudinal axis and a width in a direction transverse to the central longitudinal axis. The first end portion of the body, along which the appendage is moved at step 810, can include a first plurality of massage textures that extend out from the first end portion of the body and a first plurality of lower surface elevations adjacent the first plurality of massage textures. The first end portion of the body can define a first end portion first width, in the direction transverse to the central longitudinal axis, at the first plurality of massage textures and a first end portion second width, in the direction transverse to the central longitudinal axis, at the first plurality of lower surface elevations. And, the first end portion first width can be greater than the first end portion second width.

At step 820, the method 800 includes moving the appendage along an intermediate portion of the body of the massage device. The intermediate portion can be located along the central longitudinal axis between the first end portion of the body and a second end portion of the body. The intermediate portion can include a third plurality of massage textures that extend out from the intermediate portion of the body and a third plurality of lower surface elevations adjacent the third plurality of massage textures. The intermediate portion of the body can define an intermediate portion first width, in the direction transverse to the central longitudinal axis, at the third plurality of massage textures and an intermediate portion second width, in the direction transverse to the central longitudinal axis, at the third plurality of lower surface elevations. And, the intermediate portion first width can be greater than the intermediate portion second width.

At step 830, the method 800 includes moving the appendage along the second end portion of the body of the massage device. The second end portion of the body can include a second plurality of massage textures that extend out from the second end portion of the body and a second plurality of lower surface elevations adjacent the second plurality of massage textures. The second end portion of the body can define a second end portion first width, in the direction transverse to the central longitudinal axis, at the second plurality of massage textures and a second end portion second width, in the direction transverse to the central longitudinal axis, at the second plurality of lower surface elevations. And, the second end portion first width can be greater than the second end portion second width.

As described and illustrated elsewhere in this disclosure, with respect to the massage device used in the execution of the method 800, the intermediate portion first width can be greater than each of the first end portion first width and the second end portion first width. And, as also described and illustrated elsewhere in this disclosure, with respect to the massage device used in the execution of the method 800, the body of the massage device can be one of oval and ovoid shaped.

As noted, the appendage moved along the first, intermediate, and second end portions of the massage device can be, for example, a foot. More particularly, in one more specific such embodiment, the method 800 can include moving a plantar fascia of a foot along the first, intermediate, and second end portions of the massage device. Accordingly, in such an embodiment, the method 800 can include placing a foot into contact with the body of the massage device and then moving the plantar fascia of such foot over the first plurality of massage textures, the second plurality of massage textures, and the third plurality of massage textures. For instance, the plantar fascia of such foot can be moved over one of the first plurality of massage textures at the first end portion and the second plurality of massage textures at the second end portion before the plantar fascia is moved over the third plurality of massage textures at the intermediate portion. In another instance, the plantar fascia of such foot can be moved over the third plurality of massage textures at the intermediate portion before the plantar fascia is moved over one of the first plurality of massage textures at the first end portion and the second plurality of massage textures at the second end portion.

In carrying out the method 800 using a massage device as disclosed herein, while the appendage (e.g., foot, such as plantar fascia of the foot) is moved along the intermediate portion of the body, the appendage can diverge outward from the central longitudinal axis of the body. And, while the appendage (e.g., foot, such as plantar fascia of the foot) is moved along at least one of the first end portion of the body and the second end portion of the body (e.g., when the appendage is moved along massage textures at one of the first end portion of the body and the second end portion of the body at a first time before the appendage is moved along massage textures at the intermediate portion of the body and when the appendage is moved along massage textures at the other of the first end portion of the body and the second end portion of the body at a second, different time after the appendage has been moved along massage textures at the intermediate portion of the body), the appendage encroaches inward toward the central longitudinal axis of the body.

As noted previously, the massage device and massage method embodiments disclosed herein can be useful in helping to provide a therapeutic effect at tissue (e.g., soft tissue) of an appendage, such as the foot. As one such example, these massage device and massage method embodiments disclosed herein can be effective in helping to treat and reduce inflammation at tissue of an appendage (e.g., the foot, such as at the plantar fascia of the foot). This therapeutic effect at the tissue can be facilitated by, for instance, the disclosed device configuration providing a relatively protruded portion—the intermediate portion—between more relatively set back portions—the first end portion and the second end portion—such that a user can move his or her foot, or other body part, from a relatively set back portion—one of the first or second end portion—over a relatively protruded portion—the intermediate portion—and then over a relatively set back portion—the other of the first or second end portion all the while contacting the foot, or other body part, at the various the massage textures (e.g., and the various lower surface elevations) at each of the relatively set back and protruded portions. Moreover, the disclosed configuration can include massage textures that extend out from the body of the massage device and lower surface elevations adjacent such extended massage textures such that a portion of a foot, when in contact with the massage device, can have a first foot portion in contact with one or more of the massage textures, while another, second foot portion that is adjacent the first foot portion can extend at least partially in between such massage textures and toward the lower surface elevations such that this second foot portion is at a lower elevation (e.g., closer to the central longitudinal axis) than the first foot portion that is contact with the one or more massage textures. It is believed that such a configuration of a massage device (e.g., the noted sequential protruding and set back contouring and/or the extended massage textures and adjacently positioned lower surface elevations), and use of an associated method with such a sequence of movement carried out using such a massage device, can facilitate improved therapeutic effects at tissue (e.g., soft tissue of the foot) in a cost-effective and efficient manner.

Various non-limiting exemplary embodiments have been described. It will be appreciated that suitable alternatives are possible without departing from the scope of the examples described herein.

What is claimed is:

1. A massage device comprising:
an ovoid shape defining a central plane extending through its longest dimension:
a first plurality of protuberances on an outside surface of the ovoid shape, the first plurality of protuberances extending in a direction normal to a first side of the central plane, each of the first plurality of projections terminating in a curved surface; and
a second plurality of protuberances on the outside surface of the ovoid shape, the second plurality of protuberances extending in a direction normal to a second side of the central plane, the second side being opposite the first side, each of the second plurality of protuberances terminating in a curved surface.

2. The massage device of claim 1, wherein each of the first plurality of protuberances terminate in a conical shape.

3. The massage device of claim 1, wherein each of the second plurality of protuberances terminate in a conical shape.

4. A massage device comprising:
an ovoid shape defining a central axis extending through the longest dimension;
a plurality of protuberances on an outside surface of the ovoid shape extending outward from the ovoid shape, the plurality of protuberances arranged in a plurality of rows extending approximately perpendicular to the central longitudinal axis, each of the plurality of protuberances terminating in a curved surface.

5. The massage device of claim 4, wherein the plurality of rows are evenly spaced about the central axis.

6. The massage device of claim 4, wherein the plurality of protuberances are arranged in five or more rows.

7. The massage device of claim 4, wherein a first one or more of the plurality of rows are symmetrical to a second one or more of the plurality of rows about a plane defined perpendicular to the central axis.

8. The massage device of claim 7, wherein the plane is defined at a widest portion of the ovoid shape.

9. The massage device of claim 4, wherein a first plurality of protuberances terminate in a first curved surface and a second plurality of protuberances terminate in a second curved surface, different than the first curved surface.

10. A massage device comprising:
a body defining a central longitudinal axis, the body defining a width in a direction transverse to the central longitudinal axis;
a first end portion of the body, the first end portion of the body including a first plurality of massage textures that extend out from the first end portion of the body and a first plurality of lower surface elevations adjacent the first plurality of massage textures, wherein the first end portion of the body defines a first end portion first width, in the direction transverse to the central longitudinal axis, at the first plurality of massage textures and a first end portion second width, in the direction transverse to the central longitudinal axis, at the first plurality of lower surface elevations, and wherein the first end portion first width is greater than the first end portion second width;
a second end portion of the body, the second end portion of the body including a second plurality of massage textures that extend out from the second end portion of the body and a second plurality of lower surface elevations adjacent the second plurality of massage textures, wherein the second end portion of the body defines a second end portion first width, in the direction transverse to the central longitudinal axis, at the second plurality of massage textures and a second end portion second width, in the direction transverse to the central longitudinal axis, at the second plurality of lower surface elevations, and wherein the second end portion first width is greater than the second end portion second width; and
an intermediate portion of the body located along the central longitudinal axis between the first end portion of the body and the second end portion of the body, the intermediate portion of the body including a third plurality of massage textures that extend out from the intermediate portion of the body and a third plurality of lower surface elevations adjacent the third plurality of massage textures, wherein the intermediate portion of the body defines an intermediate portion first width, in the direction transverse to the central longitudinal axis, at the third plurality of massage textures and an intermediate portion second width, in the direction transverse to the central longitudinal axis, at the third plurality of lower surface elevations, and wherein the intermediate portion first width is greater than the intermediate portion second width,
wherein the intermediate portion first width is greater than each of the first end portion first width and the second end portion first width.

11. The massage device of claim 10, wherein the body is ovoid shaped.

12. The massage device of claim 10, wherein the body is oval shaped.

13. The massage device of claim 10, wherein each of the first plurality of massage textures define a first apex that defines the first end portion first width, each of the second plurality of massage textures define a second apex that defines the second end portion first width, and each of the third plurality of massage textures define a third apex that defines the intermediate portion first width.

14. The massage device of claim 13, wherein the first apex of each of the first plurality of massage textures, the second apex of each of the second plurality of massage textures, and the third apex each of the third plurality of massage textures define an ovoid shaped profile interconnecting each of the first apex of each of the first plurality of massage textures, the second apex of each of the second plurality of massage textures, and the third apex each of the third plurality of massage textures.

15. The massage device of claim 13, wherein the first apex of each of the first plurality of massage textures, the second apex of each of the second plurality of massage textures, and the third apex each of the third plurality of massage textures define an oval shaped profile interconnecting each of the first apex of each of the first plurality of massage textures, the second apex of each of the second plurality of massage textures, and the third apex each of the third plurality of massage textures.

16. The massage device of claim 10, wherein the intermediate portion of the body includes a central location along the central longitudinal axis.

17. The massage device of claim 16, wherein the intermediate portion first width is included at the central location along the central longitudinal axis.

18. The massage device of claim 10, wherein at least some of the first plurality of massage textures and the first plurality of lower surface elevations are aligned at a first common elevation along the central longitudinal axis.

19. The massage device of claim 18, wherein at least some of the second plurality of massage textures and the second plurality of lower surface elevations are aligned at a second common elevation along the central longitudinal axis, wherein at least some of the third plurality of massage textures and the third plurality of lower surface elevations are aligned at a third common elevation along the central longitudinal axis, and wherein the first common elevation, the second common elevation, and the third common elevation are each at different locations along the central longitudinal axis.

20. The massage device of claim 10, wherein the first plurality of massage textures include a first subgroup of the first plurality of massage textures having a first length in a direction transverse to each of the central longitudinal axis and the first end portion first width and a second subgroup of the first plurality of massage textures having a second length in a direction transverse to each of the central longitudinal axis and the first end portion first width, and wherein the first length is greater than the second length.
